(19) United States
(12) Patent Application Publication
(10) Pub. No.: US 2024/0067789 A1
(43) Pub. Date: Feb. 29, 2024

(54) Structured Material

(71) Applicant: Leibniz-Institut für Neue Materialien gemeinnützige GmbH, Saarbrücken (DE)

(72) Inventors: Peter William de Oliveira, Saarbrücken (DE); Seongjun Kim, Jeju-do (KR); Eduard Arzt, Saarbrücken (DE); Jenny Kampka, Saarlouis-Picard (DE); Peter König, Lebach (DE)

(21) Appl. No.: 18/038,549

(22) PCT Filed: Dec. 3, 2021
(86) PCT No.: PCT/EP2021/084110

§ 371 Date: May 24, 2023

(30) Foreign Application Priority Data
Dec. 3, 2020 (DE) 10 2020 132 126.0

(51) Int. Cl. C08J 9/10; C08F 120/28

(52) U.S. Cl. CPC C08J 9/102; C08F 120/28; C08J 2203/04; C08J 2205/044; C08J 2333/14

(57) ABSTRACT

A composition including a photoinitiator and an azo compound are cured with the formation of bubbles. The method can also be carried out in a multi-stage method involving irradiation and heating.

### FIELD OF THE INVENTION

The invention relates to the production of structured materials, more particularly optical materials with fine bubblets.

Nanoporous materials have always drawn the attention of science to various applications, such as, for example, lightweight materials with low costs, membranes, thermal or heat insulators, and so on. Nanoporous materials might also prevent propagation of cracks and lower the refractive index of polymer materials.

The strategies for producing nanoporous materials apparently seem to be simple as follows: (i) introduction of ultrafine bubbles (nanobubbles) into monomer or oligomer solution, (ii) stabilization of the bubbles present, and (iii) polymerization and locking-in of the structure while the bubbles retain their size and shape. None of these steps, however, is easy to carry out. In the case of a single bubble in a solution, the internal pressure of the bubble, i.e. the Laplace pressure, rises significantly if the size of the bubble becomes smaller (equation 1: pressure difference in a spherical gas bubble in liquid).

$$Δ P = \frac{2}{r} γ \qquad ( Equation 1 )$$

where ΔP is the pressure difference between inside and outside of a spherical bubble having the radius r, and γ is the surface tension.

Even if the solution is supersaturated beforehand, a small disruption would lead either to a positive or negative loop and render the bubble unstable. This is the so-called Laplace pressure bubble catastrophe (LPBC), which implies that a small bubble, more particularly an ultrafine bubble, can never be thermodynamically stable. For this reason, the existence and the stability of ultrafine bubbles are still always disputed and have not been unambiguously resolved. Furthermore, the locking-in of the bubbles during the polymerization process is a further hindrance by comparison with other processes with nanoparticles. Since polymerization entails a continuous phase transition from liquid to solid, a corresponding volume contraction, and changes in the surface tension, it is difficult to keep the bubbles stable.

Consequently, gas from the bubble would diffuse into the surrounding medium and continue to contract until, owing to the positive loop, it disappears.

The majority of the most recent studies on the production of nanoporous materials have therefore concentrated on template-based techniques such as block copolymers (BCP) (N. A. Lynd, A. J. Meuler and M. A. Hillmyer, Progress in Polymer Science, 2008, 33, 875-893; D. A. Olson, L. Chen and M. A. Hillmyer, Chemistry of Materials, 2008, 20, 869-890.) Aerogels, (N. D. Hegde and A. Venkateswara Rao, Applied Surface Science, 2006, 253, 1566-1572; T. Shimizu, K. Kanamori, A. Maeno, H. Kaji, C. M. Doherty, P. Falcaro and K. Nakanishi, Chemistry of Materials, 2016, 28, 6860-6868.) and emulsion polymerization with high internal phase (HIPE) (M. Paljevac, K. Jeřabek and P. Krajnc, Journal of Polymers and the Environment, 2012, 20, 1095-1102; S. Kovačič, D. Štefanec and P. Krajnc, Macromolecules, 2007, 40, 8056-8060; R. Butler, I. Hopkinson and A. I. Cooper, Journal of the American Chemical Society, 2003, 125, 14473-14481.), where unwanted parts are subsequently removed to leave a porous structure. Although these techniques offer well-defined possibilities for the production of ordered nanostructures, the principal disadvantages are long process times for the construction, precipitation, and drying. The extraction of sacrificial components such as organic solvents by heating or specific chemicals is generally indispensable.

An alternative technique, not template-assisted, for producing porous materials is the thermoplastic foaming method using physical or chemical blowing agents. Supercritical CO₂ is one of the most widespread physical blowing agents. The foaming process is triggered either by a rapid pressure drop in an autoclave or by the transfer of CO₂-impregnated materials into a bath above the glass transition temperature (T_{g}) of the materials. Owing to the absorbency under the different external pressure or the different external temperature, supersaturated CO₂ in the polymer matrix is physically desorbed and begins to generate a foam structure. It has been shown, however, that the mean diameter of the foamed polystyrene that is achieved at 80° C. by rapid letting-off of the pressure of 380 bar is in the range from 2 to 3 μm (I. Tsivintzelis, A. G. Angelopoulou and C. Panayiotou, Polymer, 2007, 48, 5928-5939.). The size of the bubbles is too large to scatter visible light, and so the sample becomes opaque. Moreover, it is very dangerous to let off the pressure of 380 bar in a short time. By two-stage foaming or mixing of polymers with materials differing in CO₂ affinity, it would be possible to reduce the size further down into the submicro range (J. Pinto, J. Reglero Ruiz, M. Dumon and M. Rodríguez-Pérez, Journal of Supercritical Fluids The, 2014, 94; J. Pinto, M. Dumon, M. Pedros, J. Reglero Ruiz and M. Rodríguez-Pérez, Chemical Engineering Journal, 2014, 243, 428-435; J. Pinto, M. Dumon, M. A. Rodriguez-Perez, R. Garcia and C. Dietz, The Journal of Physical Chemistry C, 2014, 118, 4656-4663.). In that case, a CO₂ absorption of about 30% mass fraction is needed, corresponding to almost 180 times the volume of the polymer matrix at STP, if the pressure is let off from the outside (H. Guo and V. Kumar, Polymer, 2014, 57; H. Guo, A. Nicolae and V. Kumar, Polymer, 2015, 70, 231-241.). There have to date been as yet no reports on a practical technique for producing ultrafine bubbles.

### OBJECT

The object of the invention is to specify a method which allows fine bubblets to be generated in a polymer, a material comprising such bubblets, and use thereof.

### ACHIEVEMENT

This object is achieved by the inventions having the features of the independent claims. Advantageous developments of the inventions are characterized in the dependent claims. The wording of all of the claims is hereby made part of this description by reference. The inventions also encompass all rational and more particularly all stated combinations of independent and/or dependent claims.

Individual method steps are described in more detail below. The steps need not necessarily be carried out in the specified sequence, and the method to be outlined may also feature further, unstated steps.

The object is achieved by a method for producing structured materials, comprising the steps of:
a) providing a curable composition comprising:
a1) at least one monomer comprising at least one group amenable to non-condensative chain polymerization or polycondensation;
a2) at least one initiator for the non-condensative chain polymerization or polycondensation of the monomer;
a3) at least one azo compound;
b) curing the composition, comprising at least one irradiation, to form a structured material comprising bubblets.

Surprisingly it has now been found that the combination of initiator and azo compound enables precise control of the size and formation of the bubblets. Hence it is possible, for example, to control the moment of the decomposition of the azo compound and hence the release of the nitrogen for generating the bubblets in the course of the curing. This is the case in particular if the azo compound decomposes relatively slowly or not at all under the activation conditions for the initiator.

The composition provided may be curable by any desired curing mechanism—for example, physically curing, thermally curing, chemically curing or radiation-curable; preferably, the composition is chemically curing or radiation-curable, more preferably radiation-curable.

Physical curing, which is the least preferred refers to the simple evaporation of solvent.

In the invention, the composition is preferably a radiation-curable composition which is cured by radiation.

Radiation curing here means that the radical polymerization of polymerizable compounds is initiated as a consequence of electromagnetic and/or particulate radiation, as for example (N)IR light in the wavelength range of λ=700-1200 nm, preferably 700-900 nm and/or UV light in the wavelength range of λ=200 to 700 nm, preferably of λ=200 to 500 nm and more preferably λ=250 to 400 nm and/or electron beams in the range from 150 to 300 keV, and more preferably with a radiation dose of at least 80, preferably 80 to 3000, mJ/cm².

In the case of curing by means of (N)IR and/or UV light, it should be ensured that in this case there are photoinitiators present in the composition, as initiator, which can be decomposed by light of the irradiated wavelength to give radicals which in turn can initiate radical polymerization.

In the case of curing with electron beams, conversely, the presence of such photoinitiators is unnecessary.

This means that there are radiation-curable monomers present in the composition. The radiation-curable monomers are preferably monomers for acrylic esters, methacrylic esters and/or unsaturated polyester resins.

Unsaturated polyester resins are known per se to the skilled person.

The radiation-curable monomers are preferably monomers for methacrylates, acrylates, hydroxy, polyester, polyether, carbonate, epoxy or urethane (meth)acrylates and also (meth)acrylated polyacrylates, which may optionally be partially amine-modified.

These monomers comprise at least one, as for example one to four, preferably one to three, more preferably one to two, and very preferably precisely one, radiation-curable monomer having at least one radically polymerizable group.

Polyester (meth)acrylates are the corresponding esters of α,β-ethylenically unsaturated carboxylic acids, preferably of (meth)acrylic acid, more preferably of acrylic acid, with polyester polyols.

Polyether (meth)acrylates are the corresponding esters of α,β-ethylenically unsaturated carboxylic acids, preferably of (meth)acrylic acid, more preferably of acrylic acid, with polyetherols.

The polyetherols preferably comprise polyethylene glycol having a molar mass of between 106 and 2000, preferably 106 to 1500, more preferably 106 to 1000, poly-1,2-propanediol having a molar mass of between 134 and 1178, poly-1,3-propanediol having a molar mass of between 134 and 1178, and polytetrahydrofurandiol having a number-average molecular weight Mₙ in the range from about 500 to 4000, preferably 600 to 3000, more particularly 750 to 2000.

Urethane (meth)acrylates are obtainable, for example, by reaction of polyisocyanates with hydroxyalkyl (meth)acrylates and optionally chain extenders such as diols, polyols, diamines, polyamines or dithiols or polythiols. Urethane (meth)acrylates which are dispersible in water without addition of emulsifiers additionally contain ionic and/or nonionic hydrophilic groups, which are introduced into the urethane by synthesis components such as hydroxycarboxylic acids, for example.

Epoxy (meth)acrylates are obtainable by reaction of epoxides with (meth)acrylic acid. Examples of epoxides contemplated include epoxidized olefins, aromatic glycidyl ethers or aliphatic glycidyl ethers, preferably those of aromatic or aliphatic glycidyl ethers.

Epoxidized olefins may be, for example, ethylene oxide, propylene oxide, isobutylene oxide, 1-butene oxide, 2-butene oxide, vinyloxirane, styrene oxide or epichlorohydrin, preferably ethylene oxide, propylene oxide, isobutylene oxide, vinyloxirane, styrene oxide or epichlorohydrin, more preferably ethylene oxide, propylene oxide or epichlorohydrin, and very preferably ethylene oxide and epichlorohydrin.

Aromatic glycidyl ethers are, for example, bisphenol A diglycidyl ether, bisphenol F diglycidyl ether, bisphenol B diglycidyl ether, bisphenol S diglycidyl ether, hydroquinone diglycidyl ether, alkylation products of phenol/dicyclopentadiene, e.g. 2,5-bis[(2,3-epoxypropoxy)phenyl]octahydro-4,7-methano-5H-indene) (CAS No. [13446-85-0]), tris[4-(2,3-epoxypropoxy)phenyl]methane isomers) CAS No. [66072-39-7]), phenol-based epoxy novolacs (CAS No. [9003-35-4]) and cresol-based epoxy novolacs (CAS No. [37382-79-9]).

Aliphatic glycidyl ethers are, for example, 1,4-butanediol diglycidyl ether, 1,6-hexanediol diglycidyl ether, trimethylolpropane triglycidyl ether, pentaerythritol tetraglycidyl ether, 1,1,2,2-tetrakis[4-(2,3-epoxypropoxy)phenyl]ethane (CAS No. [27043-37-4]), diglycidyl ether of polypropylene glycol (α,ω-bis(2,3-epoxypropoxy)poly(oxypropylene) (CAS No. [16096-30-3]) and of hydrogenated bisphenol A (2,2-bis[4-(2,3-epoxypropoxy)cyclo-hexyl]propane, CAS No. [13410-58-7]).

The epoxy (meth)acrylates preferably have a number-average molar weight Mₙ of 200 to 20 000, more preferably of 200 to 10 000 g/mol and very preferably of 250 to 3000 g/mol; the content of (meth)acrylic groups is preferably 1 to 5, more preferably 2 to 4 per 1000 g of epoxy (meth)acrylate (determined by gel permeation chromatography with polystyrene as standard and tetrahydrofuran as eluent).

(Meth)acrylated polyacrylates are the corresponding esters of α,β-ethylenically unsaturated carboxylic acids, preferably of (meth)acrylic acid, more preferably of acrylic acid with polyacrylate polyols, obtainable by esterification of polyacrylate polyols with (meth)acrylic acid.

Carbonate (meth)acrylates are likewise obtainable with various functionalities.

The number-average molecular weight Mₙ of the carbonate (meth)acrylates is preferably less than 3000 g/mol, more preferably less than 1500 g/mol, more preferably less than 800 g/mol (determined by gel permeation chromatography with polystyrene as standard, tetrahydrofuran solvent).

The carbonate (meth)acrylates are obtainable in a simple way by transesterification of carbonic esters with polyhydric, preferably dihydric, alcohols (diols, e.g., hexanediol) and subsequent esterification of the free OH groups with (meth)acrylic acid, or else transesterification with (meth)acrylic esters, as is described for example in EP 0 092 269 A1. They are also obtainable by reaction of phosgene, urea derivatives with polyhydric, e.g., dihydric, alcohols.

Also conceivable are (meth)acrylates of polycarbonate polyols, such as the reaction product of one of the stated diols or polyols and a carbonic ester and also a (meth)acrylate containing hydroxyl groups.

Suitable carbonic esters are, for example, ethylene, 1,2- or 1,3-propylene carbonate, dimethyl, diethyl or dibutyl carbonate.

Suitable (meth)acrylates containing hydroxyl groups are, for example, 2-hydroxyethyl (meth)acrylate, 2- or 3-hydroxypropyl (meth) acrylate, 1,4-butanediol mono(meth)acrylate, neopentyl glycol mono(meth)acrylate, glyceryl mono- and di(meth)acrylate, trimethylolpropane mono- and di(meth)acrylate, and pentaerythritol mono-, di- and tri(meth)acrylate.

Particularly preferred monomers are methacrylates, acrylates, and modified and unmodified esters thereof. Examples are, for example, methacrylic esters or acrylic esters. Examples of (meth)acrylates containing hydroxyl groups are, for example, 2-hydroxyethyl (meth)acrylate, 2- or 3-hydroxypropyl (meth) acrylate, 1,4-butanediol mono(meth)acrylate, neopentyl glycol mono(meth)acrylate, glyceryl mono- and di(meth)acrylate, trimethylolpropane mono- and di(meth)acrylate, and pentaerythritol mono-, di- and tri(meth)acrylate.

The composition comprises at least one initiator for the non-condensative chain polymerization or polycondensation of the monomer, preferably a photoinitiator, more particularly a UV photoinitiator.

UV photoinitiators may be, for example, photoinitiators known to the skilled person, examples being those stated in “Advances in Polymer Science”, Volume 14, Springer Berlin 1974 or in K. K. Dietliker, Chemistry and Technology of UV- and EB-Formulation for Coatings, Inks and Paints, Volume 3; Photoinitiators for Free Radical and Cationic Polymerization, P. K. T. Oldring (Ed.), SITA Technology Ltd, London.

Examples of those contemplated include phosphine oxides, benzophenones,-hydroxyalkyl aryl ketones, thioxanthones, anthraquinones, acetophenones, benzoins and benzoin ethers, ketals, imidazoles or phenylglyoxylic acids and mixtures thereof. Preferred photoinitiators are those which on decomposition do not evolve any gaseous constituents such as nitrogen.

Phosphine oxides are, for example, mono- or bisacylphosphine oxides, as are described, for example, in EP 7 508 A2, EP 57 474 A2, DE 196 18 720 A1, EP 0 495 751 A1 or EP 0 615 980 A2, examples being 2,4,6-trimethylbenzoyldiphenylphosphine oxide, ethyl 2,4,6-trimethylbenzoylphenylphosphinate or bis(2,6-dimethoxybenzoyl)-2,4,4-trimethylpentylphosphine oxide.

Benzophenones are, for example, benzophenone, 4-aminobenzophenone, 4,4′-bis(dimethylamino)benzophenone, 4-phenylbenzophenone, 4-chlorobenzophenone, Michler's ketone, o-methoxybenzophenone, 2,4,6-trimethylbenzophenone, 4-methylbenzophenone, 2,4-dimethylbenzophenone, 4-isopropylbenzophenone, 2-chlorobenzophenone, 2,2′-dichlorobenzophenone, 4-methoxybenzophenone, 4-propoxybenzophenone or 4-butoxybenzophenone; α-hydroxyalkyl aryl ketones are, for example, 1-benzoylcyclohexan-1-ol (1-hydroxycyclohexyl phenyl ketone), 2-hydroxy-2,2-dimethylacetophenone (2-hydroxy-2-methyl-1-phenylpropan-1-one), 1-hydroxyacetophenone, 1-[4-(2-hydroxyethoxy)phenyl]-2-hydroxy-2-methyl-1-propan-1-one or polymer containing 2-hydroxy-2-methyl-1-(4-isopropen-2-ylphenyl)propan-1-one in copolymerized form.

Xanthones and thioxanthones are, for example, 10-thioxanthenone, thioxanthen-9-one, xanthen-9-one, 2,4-dimethylthioxanthone, 2,4-diethylthioxanthone, 2,4-diisopropylthioxanthone, 2,4-dichlorothioxanthone or chloroxanthenone.

Anthraquinones are, for example, β-methylanthraquinone, tert-butylanthraquinone, anthraquinone carboxylic esters, benz[de]anthracen-7-one, benz[a]anthracene-7,12-dione, 2-methylanthraquinone, 2-ethylanthraquinone, 2-tert-butylanthraquinone, 1-chloroanthraquinone or 2-amylanthraquinone.

Acetophenones are, for example, acetophenone, acetonaphthoquinone, valerophenone, hexanophenone, α-phenylbutyrophenone, p-morpholinopropiophenone, dibenzosuberone, 4-morpholinobenzophenone, p-diacetylbenzene, 4′-methoxyacetophenone, α-tetralone, 9-acetylphenanthrene, 2-acetylphenanthrene, 3-acetylphenanthrene, 3-acetylindole, 9-fluorenone, 1-indanone, 1,3,4-triacetylbenzene, 1-acetonaphthone, 2-acetonaphthone, 2,2-dimethoxy-2-phenylacetophenone, 2,2-diethoxy-2-phenylacetophenone, 1,1-dichloracetophenone, 1-hydroxyacetophenone, 2,2-diethoxyacetophenone, 2-methyl-1-[4-(methylthio)phenyl]-2-morpholinopropan-1-one, 2,2-dimethoxy-1,2-diphenylethan-2-one or 2-benzyl-2-dimethylamino-1-(4-morpholinophenyl)butan-1-one.

Benzoins and benzoin ethers are, for example, 4-morpholino-deoxybenzoin, benzoin, benzoin isobutyl ether, benzoin tetrahydropyranyl ether, benzoin methyl ether, benzoin ethyl ether, benzoin butyl ether, benzoin isopropyl ether or 7H-benzoin methyl ether.

Ketals are, for example, acetophenone dimethyl ketal, 2,2-diethoxyacetophenone, or benzil ketals, such as benzil dimethyl ketal.

Phenylglyoxylic acids are described for example in DE 198 26 712 A1, DE 199 13 353 A1 or WO 98/33761 A1.

Photoinitiators which can additionally be used are, for example, benzaldehyde, methyl ethyl ketone, 1-naphthaldehyde, triphenylphosphine, tri-o-tolylphosphine or 2,3-butanedione.

Typical mixtures comprise, for example, 2-hydroxy-2-methyl-1-phenylpropan-2-one and 1-hydroxycyclohexyl phenyl ketone, bis(2,6-dimethoxybenzoyl)-2,4,4-trimethylpentylphosphine oxide and 2-hydroxy-2-methyl-1-phenylpropan-1-one, benzophenone and 1-hydroxycyclohexyl phenyl ketone, bis(2,6-dimethoxybenzoyl)-2,4,4-trimethylpentyl phosphine oxide and 1-hydroxycyclohexyl phenyl ketone, 2,4,6-trimethylbenzoyldiphenylphosphine oxide and 2-hydroxy-2-methyl-1-phenylpropan-1-one, 2,4,6-trimethyl-benzophenone and 4-methylbenzophenone or 2,4,6-trimethylbenzophenone and 4-methylbenzophenone and 2,4,6-trimethylbenzoyldiphenylphosphine oxide.

Preferred among these photoinitiators are 2,4,6-trimethyl-benzoyldiphenylphosphine oxide, ethyl 2,4,6-trimethylbenzoyl-phenylphosphinate, bis(2,4,6-trimethylbenzoyl)phenylphosphine oxide, benzophenone, 1-benzoylcyclohexan-1-ol, 2-hydroxy-2,2-dimethylacetophenone and 2,2-dimethoxy-2-phenylacetophenone.

The composition further comprises at least one azo compound. This is a compound which on activation releases nitrogen. It is preferably a radical photoinitiator based on azonitriles. These compounds exhibit only little absorption in the UV range and under UV irradiation exhibit only little decomposition, depending on their structure. In particular, accordingly, they are unaffected by the activation of the initiator, more particularly the photoinitiator. It is, however, also possible that they may be activated by an appropriately strong UV irradiation.

Examples of such azo compounds are azobisisobutyronitrile (2,2′-azobis(2-methylpropionitrile), AIBN), azobiscyanovaleric acid (ACVA), 2,2′-azobis(2,4-dimethyl)valeronitrile (ABVN)), 2,2′-azobis(2-methylbutyronitrile (AMBN), 1,1′-azobis(cyclohexane-1-carbonitrile (ACCN), 1-((cyano-1-methylethyl)azo)formamide (CABN), 2,2′-azobis(2-methylpropionamide) dihydrochloride (MBA), dimethyl-2,2′-azobis(2-methyl propionate (AIBME), 2,2′-azobis[2-(2-imidazolin-2-yl)propane] dihydrochloride (AIBI), 2,2′-azobis(2,4-dimethylpentanenitrile, 1,1′-azobis(cyclohexanecarbonitrile) (ACHN), 2,2′-azobis(2-methylpropanimideamide) dihydrochloride, 2,2′-azobis(2-acetoxypropane; 2-tert-butylazo)isobutyronitrile, 2(tert-butylazo)-2-methylbutanenitrile, 1-(tert-butylazo)cyclohexanecarbonitrile or mixtures of two or more of these compounds. Particularly preferred are compounds based on azonitriles, more particularly AIBN and ABVN. Of these, ABVN is more reactive and is particularly suitable for decomposition by irradiation.

Particularly on heating to up to 120° C., more particularly up to 100° C., the decomposition begins, with release of nitrogen.

If an azo compound is used which also decomposes under UV irradiation, then this decomposition begins preferably at a different UV wavelength than the UV photoinitiator used. The photoinitiator preferably requires a longer wavelength for activation than the azo compound. For example, the photoinitiator can be activated with an irradiation at wavelengths of more than 400 nm, while the azo compound is decomposed only at wavelengths of below 400 nm, preferably below 380 nm.

One preferred composition according to the invention therefore comprises at least one radical UV photoinitiator and at least one radical initiator based on azonitrile.

In one preferred embodiment, the composition further comprises at least one surface-active agent, more particularly at least one stabilizer, more particularly a surfactant.

Specific examples of a surfactant may be nonionic surfactants such as polyoxyethylene alkyl ethers such as polyoxyethylene lauryl ether, polyoxyethylene stearyl ether, polyoxyethylene cetyl ether and polyoxyethylene oleyl ether, polyoxyethylene alkyl allyl ethers, such as polyoxyethylene octylphenol ethers, polyoxyethylene alkyl aryl ethers such as polyoxyethylene octyl phenyl ether and polyoxyethylene nonylphenyl ether, polyoxyethylene or polyoxypropylene block copolymers, sorbitan fatty acid esters such as sorbitan monolaurate, sorbitan monopalmitate, sorbitan monostearate, sorbitan monooleate, sorbitan trioleate and sorbitan tristearate, and also polyoxyethylene-sorbitan fatty acid esters such as polyoxyethylene sorbitan monolaurate, polyoxyethylene-sorbitan monopalmitate, polyoxyethylene sorbitan monostearate, polyoxyethylene sorbitan trioleate and polyoxyethylene sorbitan tristearate; fluoro surfactants such as Megaface F-171, F-173, R-08, R-30, R-40, F-553 and F-554 (tradenames, products of DIC Corporation), Fluorad FC-430, FC-4430 and FC-431 (tradenames, products of 3M Advanced Materials Division), AsahiGuard AG710 and Surflon S-382, SC101, SC102, SC102, SC103, SC104, SC105 and SC106 (tradenames, products of AGC Seimi Chemical Co. Ltd.); and organosiloxane polymers such as BYK-302, BYK-307, BYK-322, BYK-323, BYK-330, BYK-333, BYK-370, BYK-375 and BYK-378 (tradenames, products of BYK-Chemie Wesel), more particularly on the basis of polyether-modified dimethylpolysiloxanes.

The at least one surfactant is used preferably in an amount of 0 to 2 wt %, more particularly 0 to 1 wt %, especially 0 to 0.5 wt % based on the overall composition.

Furthermore, the compositions which can be used in the method of the invention may additionally contain 0 to 10 wt % of further additives.

Further additives used may be activators, filling agents, pigments, dyes, thickeners, thixotropic agents, viscosity modifiers, plasticizers or chelating agents.

Preferably, all of the constituents are soluble in one another and form a homogeneous composition.

Moreover, the composition may further comprise a solvent, but is preferably solvent-free.

In one preferred embodiment, the composition comprises 0.01 to 5 wt % of at least one initiator, based on the overall composition, preferably 0.01 to 1 wt %, more particularly 0.01 to 0.5 wt %.

In one preferred embodiment, the composition comprises 0.01 to 20 wt % of at least one azo compound, based on the overall composition, preferably 1 to 10 wt %, more particularly 2 to 8 wt %.

In one preferred embodiment, the composition comprises 0.01 to 1 wt % of at least one initiator, based on the overall composition, and 0.01 to 20 wt % of at least one azo compound, based on the overall composition, preferably 1 to 10 wt %, more particularly 2 to 8 wt %.

In one embodiment of the invention, the composition comprises 50 to 99 wt % of at least one monomer, 0.01 to 5 wt % of at least one initiator, 0.01 to 20 wt % of at least one azo compound, and 0 to 2 wt % of at least one surfactant.

In one embodiment of the invention, the composition comprises 50 to 99 wt % of at least one monomer, 0.01 to 1 wt % of at least one initiator, 1 to 10 wt % of at least one azo compound, and 0 to 1 wt % of at least one surfactant.

In a further embodiment of the invention, the amount and nature of the azo compound are employed such that the volume of the maximally releasable nitrogen (at STP) relative to the volume of the composition amounts to not more than 50:1, more particularly not more than 20:1, especially not more than 10:1.

The providing of the composition preferably comprises the application of the composition to a surface, as a coating, or its introduction into a mold.

The composition is then cured, to form a structured material. Curing of the composition comprises at least one irradiation, to form a structured material comprising bubblets.

Where necessary, drying may be carried out. This is carried out below the decomposition temperature of the constituents of the composition.

The composition may be cured under an oxygen-containing atmosphere or under inert gas.

The radiation curing takes place with high-energy light, e.g., (N)IR, VIS or UV light, or electron beams, preferably UV light.

Suitable radiation sources for the radiation curing are, for example, low-pressure and medium-pressure mercury emitters, high-pressure emitters, and also fluorescent tubes, pulsed emitters, metal halide emitters, LED or excimer emitters. The radiation curing is accomplished by exposure to high-energy radiation, i.e., UV radiation, or daylight, preferably light in the wavelength range of λ=200 to 700 nm, more preferably of λ=200 to 500 nm and very preferably λ=250 to 400 nm. Examples of radiation sources used are high-pressure mercury vapor lamps, lasers, pulsed lamps (flashlight) or halogen lamps or excimer emitters. The irradiation dose is preferably 80 to 3000 mJ/cm², preferably 2700 mJ/cm².

It is of course also possible to use multiple radiation sources for the curing, e.g., two to four.

These may also each emit in different wavelength ranges.

It is also possible to carry out the irradiation in multiple steps at different wavelengths, in order, for example, to exert selective control over the decomposition of the azo compound. Hence it is conceivable, for example, in a first step to initiate only or primarily the photoinitiator, and hence the polymerization of the at least one monomer, and to initiate the decomposition of the azo compound only in a second step, by irradiation at a different wavelength.

The irradiation may optionally also be carried out in the absence of oxygen, e.g., under an inert gas atmosphere. Suitable inert gases are preferably nitrogen, noble gases, carbon dioxide, or combustion gases. The irradiation may additionally take place with the coating material covered with transparent media. Transparent media are, for example, polymeric films or glass.

In that case it is necessary for the transparency of the covering for the radiation employed to be harmonized with the photoinitiator used.

Hence, for example, PET is transparent for radiation with a wavelength below 300 nm. Examples of photoinitiators contemplated which generate radicals under such radiation include 2,4,6-trimethylbenzoyldiphenylphosphine oxide, ethyl 2,4,6-trimethylbenzoylphenylphosphinate and bis(2,4,6-trimethylbenzoyl)phenylphosphine oxide.

In one particularly preferred embodiment, the curing is carried out in at least one of the following ways:
1. Complete polymerization of the composition and subsequent heating to decompose the azo compound;
2. Partial polymerization of the composition by excitation of the initiator and subsequent heating to decompose the azo compound, with simultaneous irradiation;
3. Complete polymerization of the composition and decomposition of the azo compound by single-stage or multistage irradiation.

The advantage of the two-stage methods lies in particular in that the formation of the bubblets can be observed over the temperature and the duration of the heating, so enabling better optimization of the method in order to obtain a defined bubble density or bubble size. This relates in particular to the simultaneous heating and irradiation. As a result, on release of the nitrogen, the material is not yet completely polymerized.

During the irradiation as well it is possible to alter the intensity and/or wavelength of the irradiation in multiple stages, in order, for example, to initiate the decomposition of the azo compound only after a first partial polymerization. This is especially preferred if, as in technique 3, no heating is carried out. It is possible accordingly, for example, in a first step to initiate the polymerization by irradiation at a first wavelength. The decomposition of the azo compound takes place by later irradiation at a second wavelength. This second irradiation may also take place additionally to the first. It is also possible for the intensity of the irradiation in the wavelength range of the azo compound to be lower than in the range for the photoinitiator. Preference is given to an at least multi-stage, more particularly two-stage, irradiation.

The step of the curing in which the decomposition of the azo compound takes place is continued until the bubblets of the desired size are present.

Depending on the respective method, the constituents of the composition, monomer, photoinitiator and azo compound, and also, where present, preferably the stabilizer as well, may be adapted accordingly.

As a result of the prior at least partial polymerization, excessive enlargement of the bubblets, or the escape of nitrogen from the composition, is prevented. At the same time, severe foaming is avoided, and instead fine bubblets are obtained.

Hence the viscosity of the composition increases through the polymerization of the monomer, and this reduces bubblet growth triggered by the azo compound.

The addition of surfactants additionally reduces the surface tension of the composition, and this promotes the formation of bubblets, and also reduces the diameter of the bubblets.

In one preferred embodiment of the invention, the composition is heated to less than 120° C., more particularly to less than 100° C., more particularly less than 70° C. As a result it is possible to apply a coating structured in accordance with the invention even to temperature-sensitive substrates.

The duration of the heating is preferably less than one minute, more particularly less than 40 seconds.

The duration of irradiation is preferably up to 10 minutes, preferably up to 5 minutes. This is the case for a single-stage and for multistage methods. In the case of simultaneous heating, the irradiation may last for as long as the heating.

The bubbles which form have a refractive index of approximately 1 and so may contribute to reducing scattering.

Curing is preferably carried out until bubblets are obtained having a mean diameter of less than 1 μm, more particularly less than 500 nm, more particularly less than 300 nm. This may be determined by determining the mean diameter of at least 40 bubblets by SEM in a cross section of the material.

Especially if particularly small bubblets are embedded, a transparent structured material can be obtained.

As a result of the complete polymerization of the composition, the bubblets are fixed and the structure present in the material remains stable.

The invention therefore relates to a structured material produced with the method of the invention.

Such a material comprises a polymer matrix which includes a multiplicity of closed cavities (bubblets) having a diameter of less than 1 μm, more particularly of less than 500 nm, especially of below 300 nm. These cavities are preferably distributed in the material. This size applies preferably to at least 50%, more particularly at least 60%, especially at least 80% of the cavities. These details apply preferably to the maximum diameter of the cavities. The determination is made preferably by SEM, based on 100 cavities in a cross section through the material, with the cavities evaluated in the cross section each being not more than 20 μm removed from one another.

In one preferred embodiment of the invention, the structured material is optically transparent. The presence of the bubblets may be verified in particular by scattering of laser light.

The material of the invention can be used in numerous, especially optical, applications. This relates in particular to applications where an optically transparent material having scattering properties is required.

The material may be applied to smooth or structured surfaces as a coating, which may also itself have been structured, by impression, for example.

The structured material of the invention is especially suitable for producing or coating optical elements. These optical elements are suitable in particular as holographic applications, light management foils, diffusors, planar gradient index lenses in imaging optics, head-up displays, head-down displays, optical waveguides, especially in optical communications and transmission technology, and optical data stores. Examples of optical elements which can be produced are security holograms, picture holograms, digital holograms for information storage, systems with components which process optical wavefronts, planar waveguides, beam splitters, and lenses.

The material of the invention may be produced, accordingly, on an impressed optical structure, for example. The bubblets in this case are produced with such fineness that the material remains optically transparent. The presence of the bubblets may then be verified by scattering of laser light. The feature itself is not copyable with normal means, since the internal structure of the material cannot be copied.

Further details and features are apparent from the description hereinafter of preferred exemplary embodiments in conjunction with the dependent claims. In these cases the respective features may be actualized on their own or multiply in combination with one another. The possibilities for achieving the object are not restricted to the exemplary embodiments.

Thus, for example, range indications always encompass all-unstated-intermediate values and all conceivable subintervals.

The exemplary embodiments are represented schematically in the figures. Identical reference ciphers in the individual figures here designate identical or functionally identical elements or those which correspond to one another in terms of their functions. In detail:

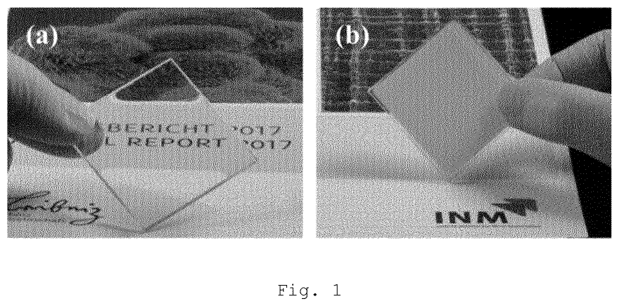

FIG. 1 shows PHEMA films after heating at 120° C. for one hour (a) without AIBN (b) with AIBN;

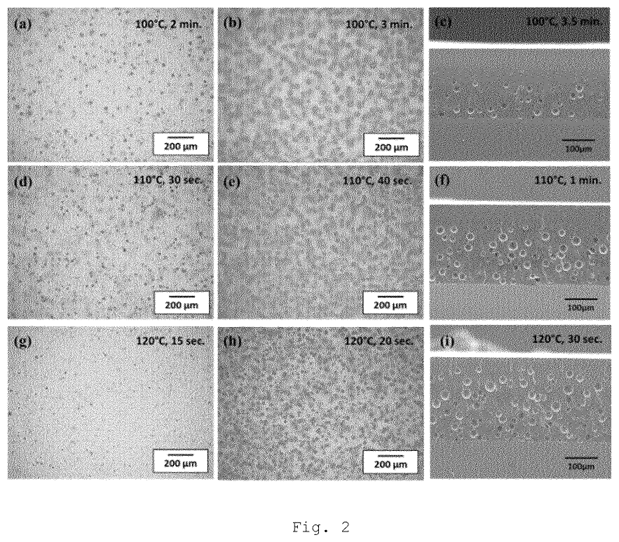

FIG. 2 shows micrographs (in situ) of UV-cured PHEMA films during subsequent heating (a), (b): 100° C. after 2 min, 3 min; (d), (e): 110° C. after 30 s, 40 s, (g), (h): 120° C. after 15 s, 20 s. SEM micrographs of cross sections of foamed PHEMA films after the sample had become white for (c) 100° C., 3.5 min (f) 110° C., 1 min. (i) 120° C., 30 s;

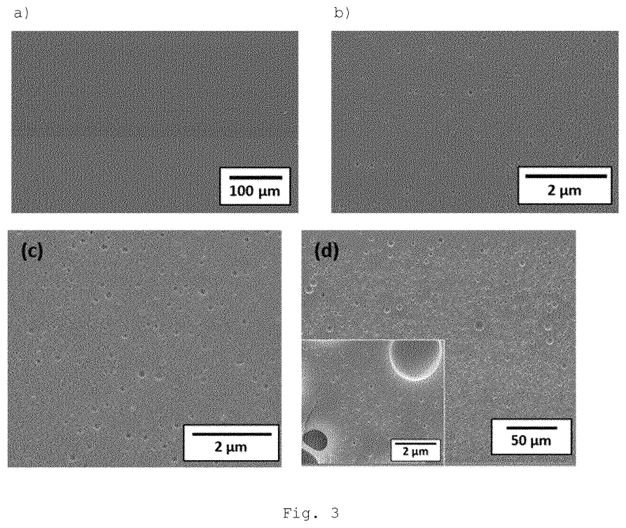

FIG. 3 shows SEM micrographs of cross sections of foamed PHEMA films (a) with AIBN and BYK378 0.4 wt % at 110° C. for 45 s; (HEMA (10 g), AIBN (0.32 g), Irgacure 819 (0.02 g)+BYK 378 (0.4 wt %)); (b) enlarged detail from the middle of a); (c) ABVN and BYK 378 0.4 wt % at 110° C. for 10 s and (d) 30 sec; detail shows an enlarged detail; all films were prepolymerized with UV light and then cured on a hotplate with formation of the nanobubblets;

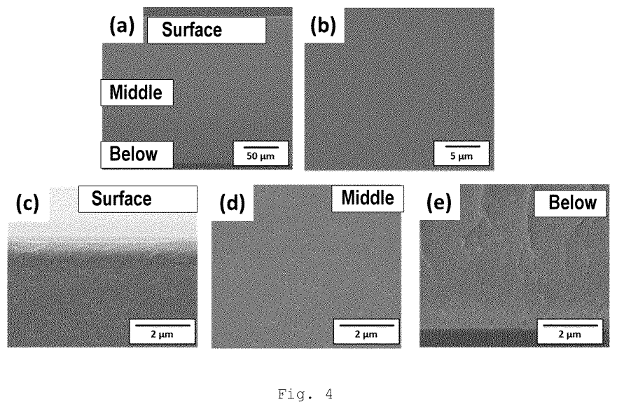

FIG. 4 shows SEM micrographs of a PHEMA film with nanobubblets, (HEMA (10 g), ABVN (0.65 g), Irgacure 819 (0.03 g)+BYK 378 (0.4 wt %)) prepolymerization with UV light heating on a hotplate at 110° C. for 10 s (a) low magnification, b) highly enlarged view of the center of a); c), d) e) enlarged views of surface, middle and below as marked in a);

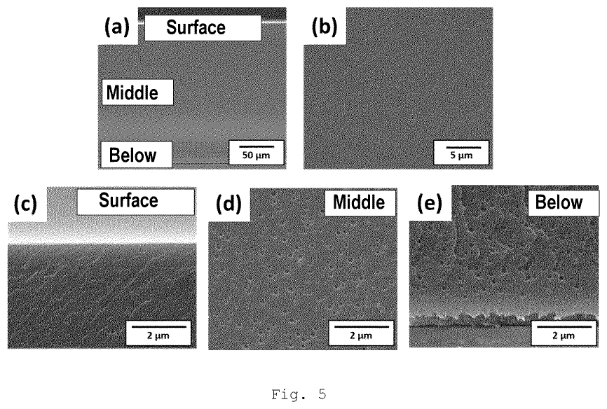

FIG. 5 shows SEM micrographs of a PHEMA film with nanobubblets, (HEMA (10 g), ABVN (0.65 g), Irgacure 819 (0.03 g)+BYK 378 (0.4 wt %)) prepolymerization with UV light heating on a hotplate at 70° C. for 30 s in combination with UV light a) low-enlargement view, b) highly enlarged view of the center of a); c), d) e) enlarged views of surface, middle and below as marked in a);

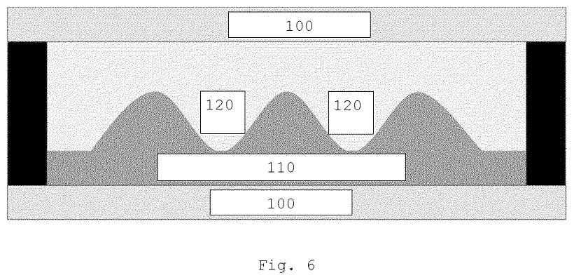

FIG. 6 shows a schematic representation of a security hologram between two glass plates 100, an impressed structure 110 and regions with nanobubblets 120;

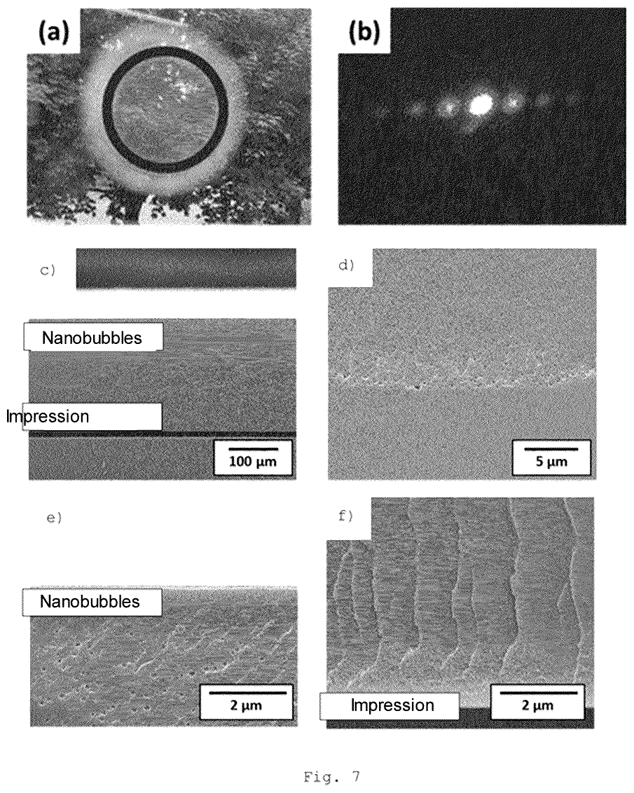

FIG. 7 shows images of a (a) transparent impressed security marking (blue circle) and (b) diffraction pattern of the security marking on a black surface with a red laser pointer; SEM micrographs of the film: c) interface between impressed structure (impression) and porous region (nanobubblets); d) enlarged detail from (c) (red rectangle); d), e) enlarged view from the nanobubblet and impression regions from (c); and

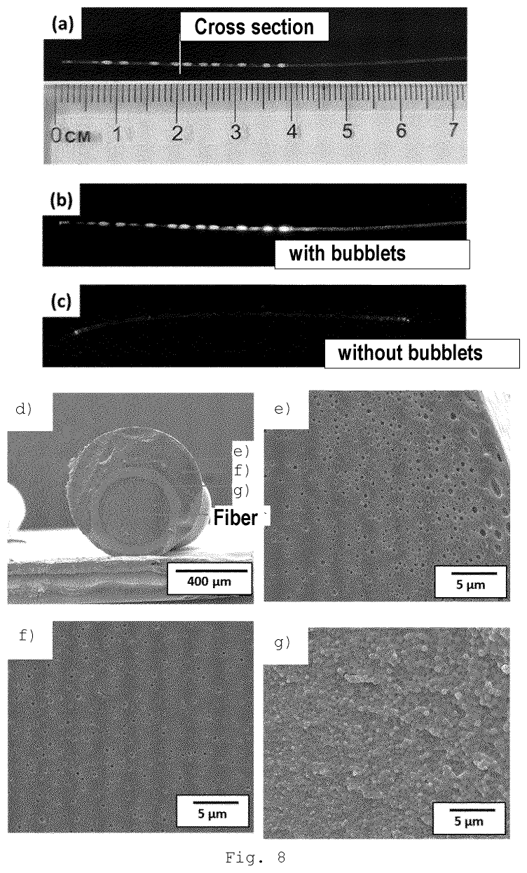

FIG. 8 shows a depiction of (a) PLA glass fiber with ultrafine bubblets (white spots), (b) outcoupling of light through the bubblets, (c) control sample without bubblets; SEM micrographs: (d) cross section of the coated fiber with bubblets, the arrows showing the positions of the enlarged micrographs e), f) and g).

### EXPERIMENTS AND MATERIALS

2-HEMA (2-hydroxyethyl methacrylate, 98%) and AIBN (2,2′-azobis(2-methylpropionitrile), 98%) were purchased from Sigma Aldrich. The UV initiator IRGACURE 819 was purchased from Ciba Spezialitätenchemie AG. V-65 (2,2′-azobis(2,4-dimethylvaleronitrile) was purchased from FUJIFILM Wako Chemicals, Europe GmbH. BYK-378 surfactants were purchased from BYK (BYK Additives and Instruments, Germany). All of the materials were used without further purification.

Two different UV lamps (M405LP1-C5, THORLABS and Thermo-Oriel (1000 W). Intensity: UV-A 20 800 mW/cm², UV-B 18 200 mW/cm², UVC 2894 mW/cm², total 86 300 mW/cm²) were used in order to initiate the polymerization and, respectively, the process after bubble formation.

### General Method for Producing PHEMA Film with Bubbles

A mixture of HEMA monomer (10 g), AIBN (0.32 g) and Irgacure 819 (0.02 g) was stirred at room temperature for 1 h. The mixture was introduced between two glass substrates—one of them was treated with a nonstick silanization—using 200 μm masking tape as spacer, and was then irradiated for 5 min with a UV lamp (wavelength 405 nm). After the UV irradiation, the nonstick glass was removed. For the generation of bubbles, the film on the glass substrate was transferred to a hotplate at different temperatures above the transition temperature (Tg) of PHEMA, and cooled to room temperature. The different foaming conditions, i.e., temperature and time, were determined experimentally if the films became white (opaque). During the foaming, the samples on the hotplate were placed under an optical microscope for measurement in situ of the nucleation and the growth of the bubbles. A further film without AIBN, containing only the monomer and Irgacure was produced as a reference.

### Generation of Ultrafine Bubbles

Foaming Starting from Fully Cured HEMA.

A BYK 378 surfactant (0.4 wt %) was added to the mixture. The foaming conditions on the hotplate were carefully monitored to the point shortly before the film began to become white (opaque). Furthermore, AIBN was replaced by ABVN.

Foaming Starting from Partially Cured HEMA.

The mixture was partially cured, rather than being fully cured, under the UV lamp for 2 minutes. The partially cured HEMA with high viscosity was then transferred to the hotplate at 70° C., i.e., below the Tg of PHEMA, and was irradiated together for a further 2 min with UV radiation (1000 W).

### ANALYSIS

PHMEA films having undergone preliminary UV curing remained transparent in both cases, both with AIBN and without AIBN, as represented in FIG. 1 (a). Since the polymerization was triggered primarily by the photoinitiator Irgacure 819 and UV radiation with a wavelength of 405 nm, AIBN, which has a principal absorption maximum at 350 nm, remained mostly unreacted.

If, however, the film is then heated above the decomposition temperature of AIBN and the glass transition temperature of PHEMA, it was possible to use AIBN only as a chemical blowing agent, with delivery of nitrogen gas for the formation of bubbles. The film therefore becomes opaque (white) when the bubbles begin to grow in the PHEMA film, as represented in FIG. 1 (b). Conversely, without AIBN, the film remains transparent after heating. Other studies reported the possibility of using azo initiator as CBA (chemical blowing agent) (M. Přádný, M. Šlouf, L. Martinová and J. Michálek, e-Polymers, 2010, 10, 1 Article number 043 (ISSN 1618-7229); L.-Z. Guo, X.-J. Wang, Y.-F. Zhang and X.-Y. Wang, Journal of Applied Polymer Science, 2014, 131, 40238. DOI: 10.1002/app.40238).

In contrast to the two-stage method, however, the thermal decomposition starts from liquid monomer solutions of low viscosity. Consequently, either the pores were stretched in a vertical direction, owing to the propulsion effects, or the size of the pores was in a range of 50-100 μm. It should be borne in mind that the amounts of azo initiators not only influence the amount of nitrogen gases generated but also influence the free radicals, which alter the polymerization kinetics. This is the main disadvantage of using CBA in the earlier reports.

A further advantage of the two-stage foaming is that after the preliminary curing and subsequent heating of the PHEMA film with AIBN, the nucleation and the growth of the bubbles can be observed under the light microscope. FIG. 2 shows how nucleation begins and the nuclei grow at different temperatures. Since AIBN was able to decompose thermally more rapidly at a higher temperature (120° C.), a greater number of nuclei formed in a short time, compared with the other films, which were heated at a lower temperature (100° C.). Interestingly, it was observed that the growth of the existing bubbles and other nucleations occurred simultaneously. At certain points, owing to the light scattering caused by the bubbles, the films become opaque (there is also a change in the shape of the bubbles from spherical to ellipsoidal form, so stretching the film in a vertical direction if the heating lasts longer than 1 hour). Whereas the size and density of the bubbles could be controlled by foaming temperature and foaming time, it was impossible to achieve ultrafine bubbles.

0.32 g of AIBN (0.002 mol) was added to 10 g of HEMA monomer. Since according to the ideal gas law one mole of nitrogen gas at STP (Standard Temperature and Pressure, 0° C. and 1 atm) occupies 22.4 L, 0.002 mol of AIBN corresponds to 44.8 mL of N₂ (0.002 mol *22.4 L/mol=44.8 mL), on the assumption that all of the AIBN decomposes during heating. At 100° C., the volume might increase further to up to 61 mL (44.8*(1+100/273)=61.21 mL). The volume of HEMA monomer and PHEMA polymer is 9.35 mL (density: 1.07 g/cm³) and 8.70 mL (density: 1.15 g/cm³) respectively. The volume ratio of nitrogen gas to PHEMA film is therefore about 7:1. Taking account of the supercritical CO₂ foaming, which has a volume ratio of CO₂ to PMMA of up to 180:1, the production of ultrafine bubbles by conventional chemical foaming is virtually unachievable without further modifications.

FIG. 3 (a) shows the effect of the surfactant on the size of the bubbles. Byk 378 was added to the solution (10 g of HEMA monomer, 0.32 g of AIBN, 0.02 g of Irgacure 819, 0.4 wt % of BYK 378), in order to reduce the surface tension and the free energy which are needed in order to obtain the interface between a bubble and the surrounding matrix. If the foaming temperature and foaming time are carefully controlled, it was possible to achieve only ultrafine bubbles. As represented in FIG. 3 (b), the bubbles were unambiguously verified by means of SEM. Thereafter AIBN was replaced by ABVN. According to a report, ABVN generates nitrogen gases at least 3 times quicker than AIBN. Consequently, it was possible to reduce the foaming time significantly, from 45 seconds to 10 seconds, while the density of the bubbles, as shown in FIG. 3 (c), increased. If, however, foam formation lasts longer than 20 seconds, the bubbles begin to age, similarly as with earlier results. In spite of the aging of the bubblets, there remained ultrafine bubblets between the microbubblets (FIG. 3 (d)).

The significance of the heating time is also evident from FIGS. 4 and 5. With a heating time of more than 20 seconds at 100° C., only microbubblets were obtained.

In the case of heating to only 70° C. in combination with UV light, bubblet formation is over after 20 seconds (FIG. 5). Only nanobubblets were obtained.

### PRODUCTION OF OPTICAL DEVICES

### Impression of the Hologram Security Mark.

A PHEMA with impression structure was produced using a commercial stamping foil as the original. A mixture of HEMA and Irgacure 819 was used for copying the structure from the master foil and was cured fully by UV radiation. A further mixture of HEMA, Irgacure 819, BYK 378 and ABVN was introduced into the impression structure and placed between two slides. The foaming process ran similarly to the previously optimized manner, i.e., 2 min by UV radiation (405 nm), followed by the combination of thermal heating at 70° C. and powerful UV radiation (1000 W) for 1 min. The sample, additionally, was tested to determine whether specific diffraction patterns are observed on passage of the laser through the structured region. The microstructure and the distribution of the nanobubbles were characterized by means of SEM.

### Light-outcoupling Scattering Point in an Optical Waveguide.

A PLA (polylactic acid) optical waveguide having a diameter of 400 μm was used. The end tip of the PLA wire was dip-coated by hand in a mixture of HEMA, Irgacure 819, BYK 378 and ABVN at certain points. The dip-coated PLA wire was transferred to the N₂ flow chamber and held horizontally. The coated region was irradiated directly with UV radiation (1000 W), while the wire rotates continuously at room temperature. The outcoupling efficiency was verified in qualitative terms by the coupling of the green laser into the fiber, and the scattering effect was demonstrated. The sample was characterized with regard to the size and distribution of the bubbles by means of SEM.

### ANALYSIS

The security hologram is represented schematically in FIG. 6. In the hologram security mark, the coating of the security marking, which contained ultrafine bubblets in the impression structure, was transparent, and objects behind the coating were readily apparent, as shown in FIG. 7 (a). Moreover, the linear structure of the master impression structure was difficult to perceive with the naked eye. Apparently the coating seems to be homogeneous and clear. However, a linear diffraction pattern appeared on the screen when a red laser light passes through the sample, as shown in FIG. 7 (b). From the SEM micrographs it is clear that the two regions differ in their microstructure and in their contrast. In the upper part of the porous PHEMA layer, ultrafine bubblets were generated in the region of 50-100 nm, whereas in the lower, dense region no bubblets were recognized, as shown in FIG. 7 (c) to (f). The refractive index of each dense and porous individual PHEMA layer was 1.51 or 1.44. This kind of “invisible security marking” was able to exhibit different diffraction patterns through alteration of the structure. Furthermore, it is impossible to copy this information with a camera or a copier, since the information comes from the “inner microstructure”. In comparison to earlier techniques for producing porous materials, the method of the invention is a very cost-effective technique.

Furthermore, ultrafine bubbles in the PHEMA film serve efficiently as scattering points, as shown in FIG. 8. In the case of the demonstration with the green laser, there was a marked difference between the fiber with nanobubbles and without outcoupling coating. This phenomenon was explainable through the SEM image of the porous PHEMA coating. The amount of the scattered light could be further harmonized by a change in the thickness of the outcoupling coating or by a change in the size of the bubbles, which would lead to a tailored light-outcoupling fiber system.

### CHARACTERIZATION OF THE SAMPLES

The bubbles were characterized using an optical microscope (Nikon-Eclipse LV100ND) and a scanning electron microscope (SEM, FEI-Quanta 400f). For the SEM measurement, the surface was sputtered with gold at 20 mA for 60 seconds (JEOL JFC-1300, Auto Fine Coater). The refractive index of the films was measured by ellipsometry (EC-400, J.A. Woollam Co. Inc.). The size of the bubbles in the images from OM and SEM was analyzed using the ImageJ program.

It is anticipated that this new approach can be employed across a broad spectrum of UV-curable polymer systems such as PMMA. This could open a new doorway into various realms of materials science. Ultimately, this study would also provide greater knowledge for the thermodynamic discussion about the existence and stability of isolated ultrafine bubbles in metastable states or in polymers. In particular, the clear verification of the generation of ultrafine bubbles with successive steps such as aging and expansion of the matrix provides comprehensive information regarding the validation of the individual foaming processes.

A new technique has been described for generating microbubblets and ultrafine bubbles in transparent PHEMA using azo initiators. It has been determined that both the reduction in the surface tension of the matrix and the increase in the degree of supersaturation are decisive factors for the production of ultrafine bubbles. It has been possible to show that the foaming process can be carried out under slightly different conditions, for example, by (a) thermal heating only, (b) combination of thermal heating and UV radiation, and (c) UV radiation only at room temperature.

### REFERENCES CITED

N. A. Lynd, A. J. Meuler and M. A. Hillmyer, Progress in Polymer Science, 2008, 33, 875-893.
D. A. Olson, L. Chen and M. A. Hillmyer, Chemistry of Materials, 2008, 20, 869-890.
N. D. Hegde and A. Venkateswara Rao, Applied Surface Science, 2006, 253, 1566-1572.
T. Shimizu, K. Kanamori, A. Maeno, H. Kaji, C. M. Doherty, P. Falcaro and K. Nakanishi, Chemistry of Materials, 2016, 28, 6860-6868.
M. Paljevac, K. Jeřabek and P. Krajnc, Journal of Polymers and the Environment, 2012, 20, 1095-1102.
S. Kovačič, D. Štefanec and P. Krajnc, Macromolecules, 2007, 40, 8056-8060;
R. Butler, I. Hopkinson and A. I. Cooper, Journal of the American Chemical Society, 2003, 125, 14473-14481.
I. Tsivintzelis, A. G. Angelopoulou and C. Panayiotou, Polymer, 2007, 48, 5928-5939.
J. Pinto, J. Reglero Ruiz, M. Dumon and M. Rodríguez-Pérez, Journal of Supercritical Fluids The, 2014, 94.
J. Pinto, M. Dumon, M. Pedros, J. Reglero Ruiz and M. Rodríguez-Pérez, Chemical Engineering Journal, 2014, 243, 428-435.
J. Pinto, M. Dumon, M. A. Rodriguez-Perez, R. Garcia and C. Dietz, The Journal of Physical Chemistry C, 2014, 118, 4656-4663.
II. Guo and V. Kumar, Polymer, 2014, 57;
H. Guo, A. Nicolae and V. Kumar, Polymer, 2015, 70, 231-241.
M. Přádný, M. Šlouf, L. Martinová and J. Michálek, e-Polymers, 2010, 10, 1 Article number 043 (ISSN 1618-7229).
L.-Z. Guo, X.-J. Wang, Y.-F. Zhang and X.-Y. Wang, Journal of Applied Polymer Science, 2014, 13, 131, 40238. DOI: 10.100 2/app.40238.

1. A method for producing structured materials, comprising:
a) providing a curable composition comprising:
a1) at least one monomer comprising at least one group amenable to non-condensative chain polymerization or polycondensation;
a2) at least one initiator for the non-condensative chain polymerization or polycondensation of the monomer; and
a3) at least one azo compound;
b) curing the composition, comprising at least one irradiation, to form a structured material comprising bubblets.

2. The method of claim 1, wherein the initiator a2) is a photoinitiator.

3. The method of claim 1, wherein the composition is a radiation-curable composition.

4. The method of claim 1, wherein the azo compound is a radical photoinitiator based on azonitriles.

5. The method of claim 2, wherein the photoinitiator is a UV photoinitiator.

6. The method of claim 1, wherein the composition further comprises at least one surface-active agent.

7. The method of claim 1, wherein the curing is carried out by one of the following methods:
complete polymerization of the composition and subsequent heating to decompose the azo compound;
partial polymerization of the composition by excitation of the initiator and subsequent heating to decompose the azo compound, with simultaneous irradiation; or
complete polymerization of the composition and decomposition of the azo compound by single-stage or multistage irradiation.

8. A structured material obtained by the method of claim 1.

9. The structured material of claim 8, comprising a polymer matrix including a multiplicity of closed cavities having a diameter of less than 1 μm.

10. (canceled)

11. The method of claim 1, wherein the composition further comprises at least one surfactant.

12. An optical application comprising the structured material of claim 8.
